(19) United States
(12) Patent Application Publication
(10) Pub. No.: US 2004/0120500 A1
(43) Pub. Date: Jun. 24, 2004

(54) Method and arrangement for operating a telecommunication network

(76) Inventor: Harald Hinderberger, Munchen (DE)

Correspondence Address: MORRISON & FOERSTER LLP, 1650 TYSONS BOULEVARD, SUITE 300, MCLEAN, VA, 22102, US

(21) Appl. No.: 10/473,979

(22) PCT Filed: Apr. 2, 2002
(86) PCT No.: PCT/DE02/01208

(30) Foreign Application Priority Data
Apr. 6, 2001 (DE) 10117366.0

(51) Int. Cl. H04M 7/00

(52) U.S. Cl. 379/230; 379/219

(57) ABSTRACT

The invention relates to a method and arrangement, for operating a telecommunication network (14), with a control computer (66), which controls a network element (12c) of a network node in a telecommunication network (14). In addition to the operating system thereof the control computer (66) has at least one first interface programme (80) and a signalling programme (76, 78), which carries out signalling processes between the control computer (66) and further control computers (34, 36, 38) in the telecommunication network (14). An applications computer (72), connected to the control computer (66), has, in addition to the operating system thereof, at least one second interface programme (82) and at least one application programme (84 to 92). Data is transmitted to the first interface programme (80) by means of the second interface programme (82) and received by the above, which contains signalling information. The signalling information is exchanged between the application programme (84 to 92) of the application computer (72) and the signalling programme (76, 78) of the control computer (66), by means of the both interface programmes (80, 82).

### CLAIM FOR PRIORITY

This application claims priority to DE 10117366.0, filed on Apr. 6, 2001, in the German language, the contents of which are hereby incorporated by reference.

### TECHNICAL FIELD OF THE INVENTION

The present invention relates to a system and method for operating a telecommunication network, and in particular, to a network in which a network element connected to a network node of a telecommunication network is controlled by a control computer.

### BACKGROUND OF THE INVENTION

In telecommunication networks in which in part calls are established and cleared down between terminal equipments, the Signaling System No. 7 as described for example in the relevant standards of the ITU (International Telecommunication Union) with its organ the ITU-T, previously the CCITT (International Telegraph and Telephone Consultative Committee), is used for preference. When Signaling System No. 7 is employed, the signaling is performed with the aid of central signaling channels between the network nodes of the telecommunication network.

As a rule, modern telecommunication networks have computer-controlled network nodes, between which PCM transmission links are provided for data transmission, wherein a portion of the transmission capacity of these PCM links, for example one transmission channel with a data transmission capacity of 64 kbit/s, can be used as a central signaling channel.

The Signaling System No. 7 is used to control switching operations in telecommunication networks and also in other communication networks. It is thus normal today for an independent signaling network which provides service for a wide variety of users to exist in telecommunication networks.

The signaling system provides a Message Transfer Part (MTP) which is standardized for all applications. The message transfer part is a signaling protocol which enables fast, reliable and application-independent transport above all of the signaling messages in the network, including the registration and elimination of system and network errors. Only user information connection independent services having a restricted addressing capability are offered by the message transfer part. The message transfer part provides services for a wide range of users and forms the common transport system for messages for different User Parts (UP). Thus there is for example a user part for telephone communications, the Telephony User Part (TUP), a user part for circuit-switched data services, the Data User Part (DUP), a user part for operation and maintenance functions associated with networks, the Operation and Maintenance Application Part (OMAP), a user part for ISDN signaling, the ISDN User Part (ISDN-UP), and also the user part for global networks, the Intelligent Network Application Part (INAP). The message transfer part is thus used primarily for connection control purposes for circuit-switched data transmission in order to connect the network elements of network nodes, which are also referred to as signaling transfer points or signaling points, in the Signaling System No. 7. Digital full-duplex 64 kbit/s lines or channels (for example as a V.35 access) are preferably used as the signaling path for these connections. When a signaling link is set up, in PCM30 for example, a time slot is reserved for the transmission of data with signaling information. This is normally the time slot 16. The selected channel can be set up as a fixed connection, as a so-called nailed-up connection (NUC). In addition, a Signaling Connection Control Part (SCCP), also referred to as the transport function part or control part for signaling transactions, is used for signaling purposes. The signaling connection control part utilizes the infrastructure of the message transfer part in order to transfer any desired signaling data, connection-independent signaling data in particular. With the aid of the signaling connection control part, a message exchange can be performed between two signaling points on different connection paths and on the basis of different routing information.

A so-called user protocol having a transaction capability, for example with the capability to perform database operations, is used as the interface between the signaling connection control part (SCCP) and the user protocols (user parts). This user protocol having transaction capabilities is also referred to as the Transaction Capability Application Part (TCAP). This user protocol is a signaling part which is kept very general and makes possible distributed applications including non-circuit-oriented applications in the Signaling System No. 7. With the aid of the TCAP user protocol, procedures are made available which enable the efficient handling of different service features. These procedures support the exchange of components between the individual user protocols (user parts). They are however application-independent.

The TCAP user protocol makes available procedures which enable the efficient handling of different service facilities and features. Multiple TCAP users can use these procedures as a basis for setting up their services. Messages are addressed in the signaling connection control part (SCCP) either directly or indirectly with the aid of pseudo addresses, so-called global names (GT, Global Title), which are converted into physical destination numbers with the aid of Global Title Translation (GTT).

Public telecommunication networks are overlaid by signaling networks which are based on the Signaling System No. 7 and are used for the exchange of control information. With the aid of the signaling system, user information connection independent signaling is also possible in addition to call-related signaling, as a result of which it is possible to control processes in other switching centers of the telecommunication network with the aid of standardized operations. Such a user information connection independent exchange of signaling information takes place for example with the aid of user protocols having a transaction capability, such as the TCAP protocol. These protocols generally utilize services of the signaling connection control part (SCCP) including global title translation (GTT). Applications which use the TCAP protocol are also referred to as TCAP users. Examples of such TCAP users are ISDN supplementary services, such as Completion of Call to Busy and Message Waiting Indication for example, as well as IN (Intelligent Network) services.

As a result of the increased usage of global data networks such as the Internet or a so-called wide area network in a corporate structure having distributed locations for example, there is an increasing requirement for services which are based on the transfer of signaling messages between a global network of this type and a telecommunication network. One example of a service which requires such a transfer of signaling information is the service feature “Click to Phone” or “Click to Dial”. This service feature enables an Internet user to establish a telephone connection to a data processing system connected to this network by means of an input made using a keyboard or a pointing device. This service feature can advantageously be used particularly when an Internet user is able by means of an activation action, by using a pointing device on a displayed Internet page for example, to establish a telephone connection to an expert recommended on this Internet page.

A further service feature in which a transfer of signaling information between a global network and a telecommunication network is required is the “Click to Conference” service feature. A user of the global network can use the service feature to convene a telephone conference by conveying telephone numbers of subscriber lines in the telecommunication network, between which a conference is to be set up, to another computer in the global network, with the aid of an Internet page for example. To this end, signaling information which initiates such a conferencing facility between the desired subscribers is then transferred from the global network to the telecommunication network. In this situation the interconnection for such a conference can be performed automatically complete with welcome and waiting announcements by means of an input made by one user, on an Internet page provided for this purpose for example.

As mentioned above, a cross-network exchange of control information is necessary in order to allow the execution of such services. Particularly when the network transition point (Point of Presence) between the global network and the telecommunication network and the program in the telecommunication network needed for implementing the service feature are not located in the same switching center, the onward transport of the control information in the telecommunication network needs to be guaranteed. By preference, the SCCP protocol and also the TCAP protocol are used for this purpose. Global networks, such as the Internet for example, make use of so-called Internet protocols (IP) for data transmission purposes. Global networks of this type are also referred to as Internet protocol based networks, or IP networks.

The conversion of control information from the IP network to signaling data for the Signaling System No. 7 used in the telecommunication network is typically carried out with the aid of programs having an open interface which the user or operator in question can adapt according to their requirements. Such programs are for the most part attached to the telecommunication network as a so-called open platform or commercial platform (CoP1). From the logical viewpoint, these programs are both SCCP and TCAP users. In order to provide the link to the signaling system of the telecommunication network, program modules for implementing the TCAP protocol and the SCCP protocol must be implemented on this platform. The programs for implementing the TCAP and SCCP protocols are also referred to as the SCCP/TCAP protocol stack. Thus, with the prior art, a new implementation of the SCCP/TCAP protocol stack is required for each new platform.

### SUMMARY OF THE INVENTION

The present invention relates to a method for operating a telecommunication network (sometimes referred to herein as TC network for short), wherein a network element connected to a network node of a telecommunication network is controlled by a control computer. The network element is for example a switching center for switching calls. To this control computer is connected an applications computer which has at least one application program in addition to the operating system assigned to it. By using the connection between the applications computer and the control computer, the application program has access to the signaling system of the control computer and thus to the signaling system of the telecommunication network. Furthermore, the invention relates to an arrangement for operating a telecommunication network and also to a telecommunication network.

Thus, the invention discloses a system and method in which signaling information can be exchanged easily between an application program which is not executed on a control computer in the switching center and the network element of a telecommunication network.

In one embodiment, the signaling data is transferred between the application program and the signaling system of the telecommunication network with the aid of a first and a second interface program. The SCCP/TCAP protocol stack of the network element, the SCCP/TCAP protocol stack of a coordination processor in a switching center for example, is thus utilized in order to enable the application program to exchange signaling information with the signaling network of the telecommunication network. There is no need to implement the SCCP/TCAP protocol stack on the applications computer. This results in savings not only in respect of procurement costs for the program modules for implementing the SCCP/TCAP protocol stack but the considerable time requirement for implementing these protocol stacks on the applications computer along with the necessary maintenance and support for the SCCP/TCAP protocol stack are also not required.

The first and second interface program form an interface between the application program and the TCAP protocol and are also referred to as the TCAP Application Interface (TIF). The first interface program exchanges signaling information with the TCAP protocol stack as a user part. The second interface program exchanges signaling data with the application program in the same manner as in the case of a direct access by the application program to a TCAP protocol stack implemented in the applications computer. The data exchange between the two interfaces takes place with the aid of an arbitrary data transfer protocol. The resource requirement for implementing the two interfaces amounts to approximately 10% of the resource requirement for implementing the SCCP/TCAP protocol. The signaling data is transmitted as user data between the two interfaces. This enables a simple and uncomplicated logical structure for the two interfaces.

The interface monitoring facilities, such as protocol monitoring and path selection for example, are simple and transparent thanks to the simple logic of the interface. As a result, problems can be easily detected and eliminated. The interface control can also continue to be used unmodified following a change in service features. At least the first interface can also continue to be used unmodified in the case of future extensions on other platforms. It is necessary only to adapt the second interface to the new platform, in other words the interface must be implemented on the new platform, on a different data processing system for example, unless the interface is written in a platform-independent programming language such as the Java programming language for example. The resource requirement for connecting further platforms to the signaling system of the telecommunication network can thus be further reduced.

It is advantageous if the signaling program of the control computer and signaling programs of further control computers form a self-contained signaling network within the telecommunication network. Fixed signaling channels can be set up between the control computers for the purpose of data transmission in this signaling network. As a result, the application program is also able to exchange signaling information with other network elements via the signaling network. In addition, with the aid of a signaling network of this type it is possible to transmit user information channel independent signaling messages.

In a further embodiment of the invention, the signaling operations are performed with the aid of the signaling system or with the aid of the Signaling System No. 7. As a result, the application program has access to an extremely powerful and widespread signaling system. It is thus easy to control different service facilities and features.

In a development of the invention, the signaling program makes services available to at least one user part. This user part can be the first interface program, for example. As a result of the transmission of the signaling information between the first and the second interface and also the transfer of the signaling information to and from the application program, the application program is thus able to utilize the services offered by the signaling program. The transfer of signaling information between the signaling network and the application program can thus be carried out in a simple manner.

In an advantageous embodiment, the signaling functions which the signaling program has at its disposal are made available to the application program by means of the second interface program. The application program thus has access to all the signaling capabilities which are available to the network element. A second interface can also be created in this manner which can also be used unmodified for other application programs since all the possible signaling functions are made available with the aid of the second interface program.

It is advantageous to carry out the data transfer between the first and the second interface program with the aid of an LAP-D data transfer protocol or with the aid of a data transfer protocol which is based on an Internet protocol. As a result, protocols are used for the data transfer which are simple to implement and guarantee reliable data transmission. Other data transfer protocols can also be used, however.

In another embodiment, the application program is connected not only to the second interface program but also to a data network based on an Internet protocol. Services which exchange signaling information with the telecommunication network are made available to a user with the aid of the application program via this IP network. It is thus possible, with the aid of application programs to which data can be supplied from any desired point in the IP network, to activate and utilize services and features of the telecommunication network.

Services which are offered via the IP network can thus be combined with services which are currently only available in the telecommunication network. Thus, a user of a program can, for example, establish a connection to an expert, by using a help function in this program for example, useful data generated by the program being transmitted to the workplace of the expert with the aid of the IP network and also a telephone connection to the expert being established with the aid of the telecommunication network. In order to establish this connection, the signaling data required to establish the connection is transmitted by the program to the applications computer which is likewise located in the IP network. On this applications computer is executed the application program which supports a service that allows such a connection to be established. This service is also referred to as Click to Phone or as Click to Dial. If the user is connected to the IP network by means of an analog telephone connection, this connection will be automatically interrupted when a voice connection to the expert is established so that the subscriber line will be free for the voice connection. In the case of an ISDN connection, the connection to the IP network can be maintained because the voice connection is switched via the second channel of the ISDN connection.

In still another embodiment, it is possible in a simple manner to connect up an applications computer to a signaling system of the telecommunication network. The connection of application programs to the signaling program is thus not necessarily dependent on the direct availability of SCCP/TCAP protocol stacks. Thus, applications computers with lower performance can also be used for executing the application program since there is no need to implement the SCCP/TCAP protocol stack in the applications computer. Furthermore, it is advantageous in an arrangement of this type that the application program in the applications computer has no direct access to the program system of the network element. This therefore excludes the possibility of manipulation of programs which are executed for example by a coordination processor, a group processor or a signal processor of the network element. Access to these programs by unauthorized persons is thus prevented since only signaling data can be transferred between the two interfaces, yet there is no possible way in which the applications computer can gain access to the program system of the network element. Only signaling information is transferred between the IP network and the telecommunication network with the aid of the interface programs. This thus provides separation between IP network and telecommunication network at least with regard to the transfer of signaling information.

### BRIEF DESCRIPTION OF THE DRAWINGS

Further features and advantages of the invention will emerge from the description which follows, which in conjunction with the accompanying drawings describes the invention with reference to exemplary embodiments. In the drawings:

FIG. 1 shows a number of switching centers which are connected to a telecommunication network, some of the switching centers being connected to commercial platforms which have access to the global network of the Internet.

FIG. 2 shows two switching centers of a telecommunication network, one switching center having a commercial platform which is connected to the Internet.

FIG. 3 shows the signaling system of the coordination processor of the first switching center and also of the commercial platform of the second switching center from FIG. 2.

FIG. 4 shows two switching centers of a telecommunication network, a commercial platform being connected to the second switching center.

FIG. 5 shows the signaling system of the first and second switching center and also the connection of the commercial platform to this signaling system of the arrangement shown in FIG. 4.

FIG. 6 shows a first exemplary embodiment of a possible physical link between the commercial platform and the signaling system of the coordination processor.

FIG. 7 shows a second exemplary embodiment of a possible physical link between the commercial platform and the coordination processor of the switching center.

FIG. 8 shows a third exemplary embodiment similar to the embodiment shown in FIG. 6.

FIG. 9 shows the transmission path of the signaling data from the Internet application through to the signaling system of the telecommunication network.

### DETAILED DESCRIPTION OF THE INVENTION

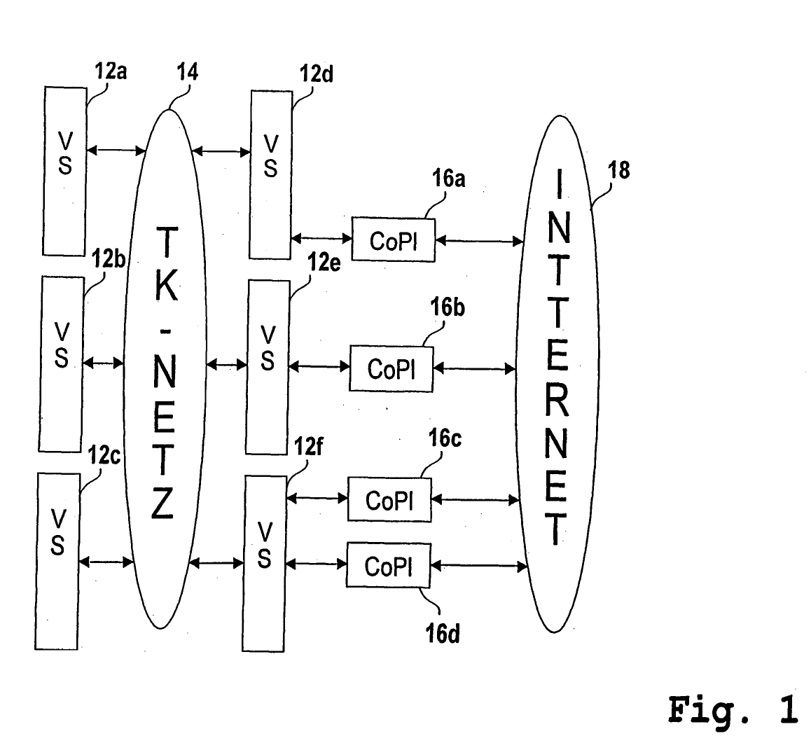

FIG. 1 shows switching centers 12a to 12f which are connected to a telecommunication network 14, TC network for short, and which in each case form a network element of a network node of the telecommunication network 14. On an applications computer (not shown), a program is executed which makes available to the user of a data network, such as the Internet 18 for example, services and service features which at least in part exchange signaling information with a signaling system of the switching center 12d. In this case, the application program on the applications computer constitutes an interface between the Internet 18 and the telecommunication network 14. This interface is also referred to as commercial platform 16a. The commercial platform 16b constitutes an interface between the Internet 18 and the switching center 12e, and the commercial platforms 16c, 16d each constitute an interface between the Internet 18 and the switching center 12f.

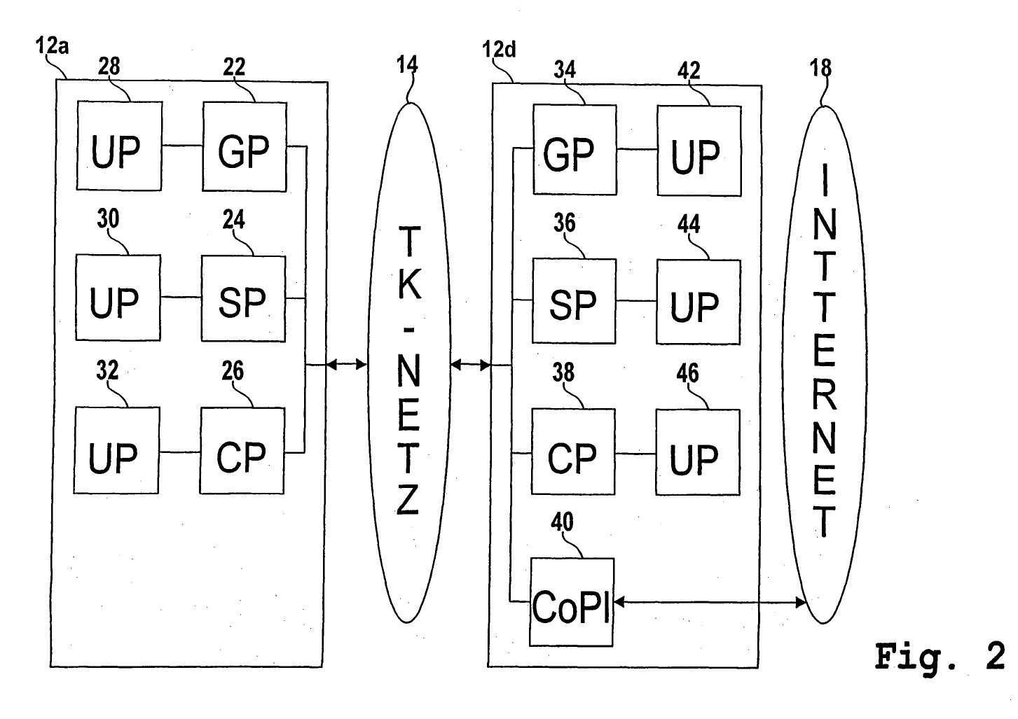

FIG. 2 shows the switching centers 12a and 12d, the telecommunication network 14 and the Internet 18. Identical elements carry the same reference characters. The switching center 12a has a group processor 22, a signaling processor 24 and a coordination processor 26. The group processor 22, the signaling processor 24 and the coordination processor 26 are each connected to the signaling system of the telecommunication network. The group processor 22, the signaling processor 24 and the coordination processor 26 make services available to different users. Separate so-called User Parts (UP) are defined for the different users. These are, for example, for telephony applications the Telephony User Part (TUP), for circuit-switched data services the Data User Part (DUP), for operation and maintenance functions associated with networks the Operations and Maintenance Application Part (OMAP) and for ISDN signaling applications the ISDN User Part (ISDN-UP), and also for mobile radio applications the Mobile User Part (MUP).

The group processor 22 of switching center 12a is connected to the User Part 28, the signaling processor 24 of switching center 12a is connected to the User Part 30 and the coordination processor 26 of switching center 12a is connected to the User Part 32. The processors 22 to 26 make available basic functions of the switching center with the result that they are also present in switching centers which provide services to no User Part or only to one User Part 28 to 32. A processor 22 to 26 can also provide services to a plurality of User Parts 28 to 32. The switching center 12d has a group processor 34, a signaling processor 36 and a coordination processor 38. The processors 34 to 38 are each connected to a User Part 42 to 46. The processors 34 to 36 each provide services to these User Parts 42 to 46, as described previously, signaling services in particular. In addition, the switching center 12d has an applications computer 40 on which at least one program module is executed which constitutes a signaling interface between the data network 18 and the telecommunication network 14. The applications computer 40 has a SCCP/TCAP protocol stack and is connected via this protocol stack to the signaling system of switching center 12d and also to the signaling system of the telecommunication network 14. The applications computer 40 and the application program which provides a user of the Internet 18 with signaling services of the telecommunication network 14 is a commercial platform.

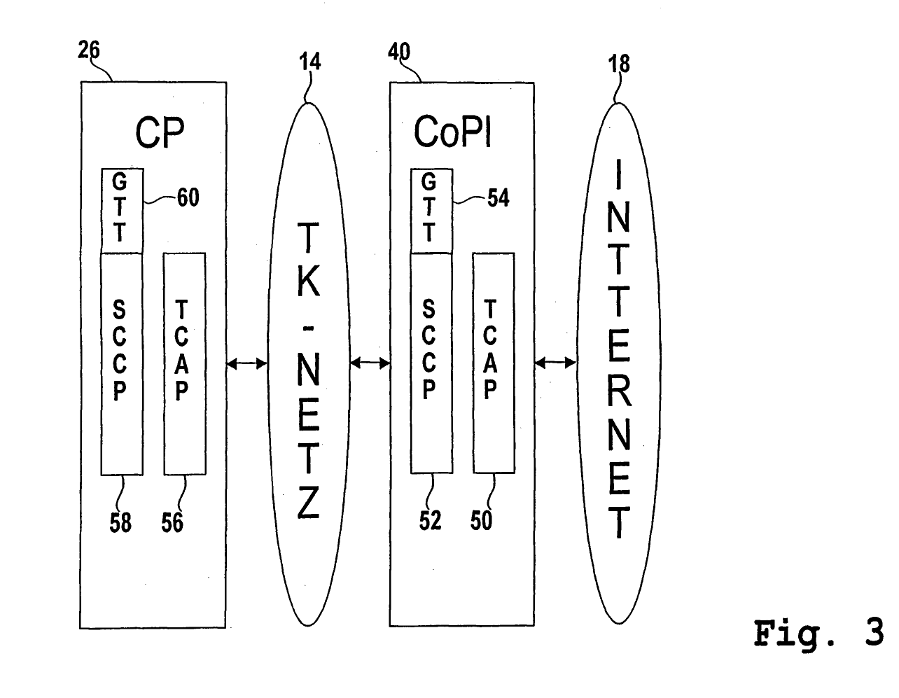

FIG. 3 shows the coordination processor 26 of switching center 12a and also the commercial platform 40 of switching center 12d, which are each connected to the signaling system of the telecommunication network 14. The coordination processor 26 has a program module 56 for provision of a user protocol having a transaction capability, the so-called TCAP protocol, a program module 58 for provision of a transport function protocol, the so-called SCCP protocol, and a program module for global number conversion, the so-called GTT program. The TCAP protocol and the SCCP protocol utilize services of the Message Transfer Part (MTP). The structure and the function of the TCAP protocol, the SCCP protocol, the Message Transfer Part MTP and the Global Title Translation GTT have already been explained in details in the introduction to this description. The TCAP protocol is also described and explained in the ITU standards Q.771 to Q.775, the SCCP protocol is described and explained in the standards Q.711 to Q.716, and the Message Transfer Part is described and explained in the standards Q.702 to Q.704.

The coordination processor 26 is connected to the signaling network of the telecommunication network 14 by means of the TCAP protocol 56 and by means of the SCCP protocol 58, the SCCP protocol 58 using services of the global title translation module 60. The applications computer of the commercial platform 40 is connected to the signaling system of the telecommunication network 14 by means of the TCAP protocol 50 and the SCCP protocol 52. A global number translation module 54 makes name conversion services available to the SCCP protocol. Thus, in order to connect the commercial platform 40 to the signaling system of the telecommunication network 14, the SCCP/TCAP protocol stack 50, 52 and also the global title translation module 54 must be installed in the commercial platform 40. Considerable expenditure is required for the procurement of the programs needed for implementation of the SCCP/TCAP protocol stack 50, 52 and considerable installation and configuration effort is required in order to install these programs on the applications computer of the commercial platform 40. Considerable resources are also required on the part of the applications computer for processing these programs.

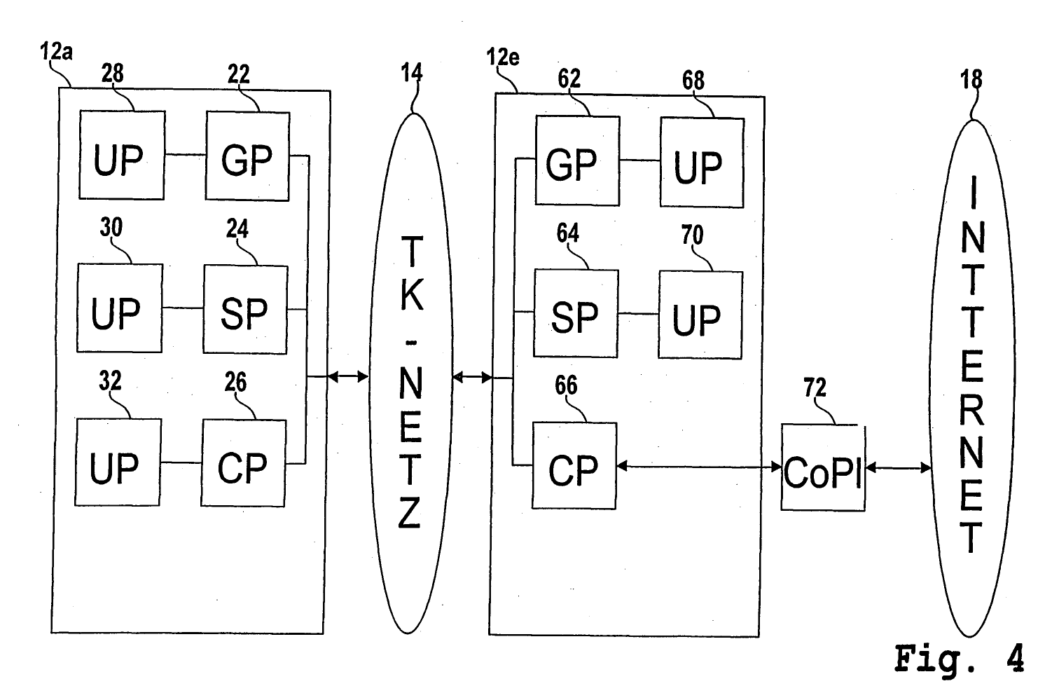

FIG. 4 shows the switching center 12a and the switching center 12e from FIG. 1, which are each connected to the telecommunication network 14. The switching center 12e has a group processor 62, a signaling processor 64 and a coordination processor 66, which are each connected to the signaling system of the telecommunication network 14. The group processor 62 makes available services to one application part, the user part 68. Services are made available to an application part 70 by the signaling processor 64. An applications computer which with the aid of program modules constitutes a commercial platform 72 is connected on the one side to the coordination processor 66 of the switching center 12e and on the other side to the Internet 18.

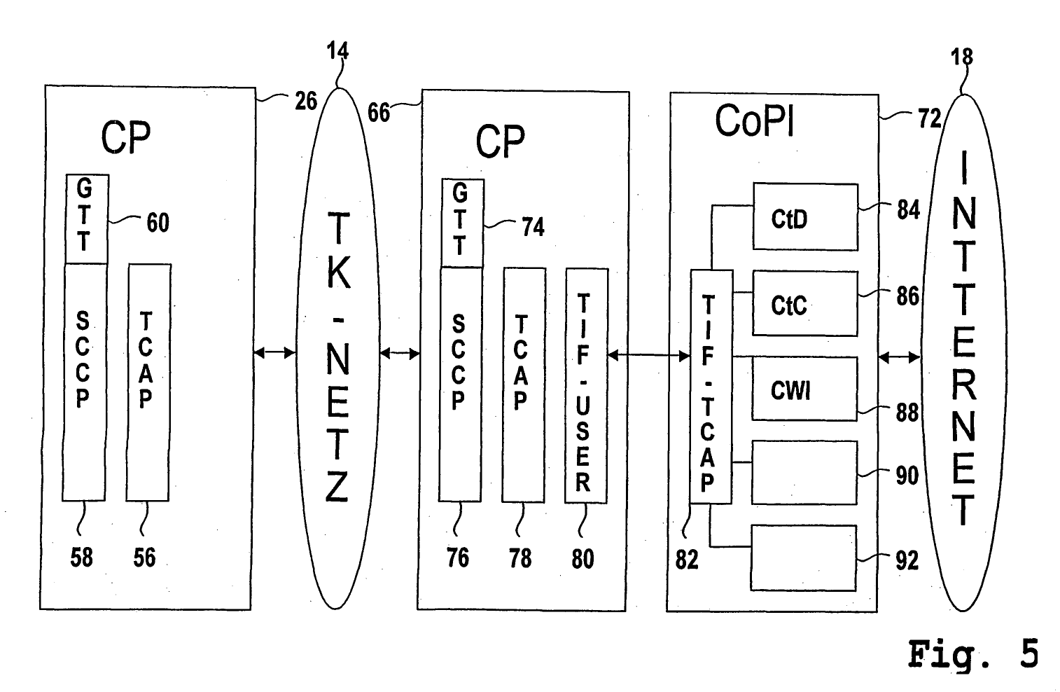

FIG. 5 shows the coordination processor 26 of the switching center 12a with the SCCP/TCAP protocol stack 56, 58 and also the global title translation module 60, which are connected to the signaling system of the telecommunication network 14. Also shown is the coordination processor 66 of the switching center 12e which has an SCCP/TCAP protocol stack 76, 78 and also a global title translation module 74. In addition, the coordination processor 66 executes a first interface program module 80 which constitutes a user part.

The SCCP/TCAP protocol stack 76, 78 makes available signaling services to the first interface program module 80. The commercial platform 72 has an application program “Click to Dial (CtD)” 84, an application program “Click to Conference (CtC)” 86, an application program “Call Waiting on Internet Busy (CWI)” 88 and also two further application programs 90, 92. These programs are connected to a second interface program 82 of the commercial platform 72. The commercial platform 72 and the coordination processor 66 of the switching center 12e are connected with the aid of a data transfer link via the interface programs 80, 82. With the aid of these interfaces 80, 82, signaling information is exchanged between the commercial platform and the signaling system of the telecommunication network 14. The data transfer between the two interfaces 80, 82 takes place with the aid of an LAP-D data transfer protocol.

The first interface program 80 behaves toward the SCCP/TCAP protocol stack 76, 80 of the coordination processor 66 in the same way for example as the user part 68 behaves toward the SCCP/TCAP protocol stack of the group processor 62. The interface program 80 thus handles the SCCP/TCAP protocol stack 76, 78 in the same way as any other user part would handle this protocol stack 76, 78, in other words the first interface program 80 completes the SCCP/TCAP protocol. The signaling data exchanged between the SCCP/TCAP protocol stack and the first interface program 80 is transferred to the second interface program 82 of the commercial platform 72. In the applications computer of the commercial platform 72, the signaling data is allocated to the relevant application program 84 to 92 with the aid of the second interface program 82 and transferred to this program. Signaling information from the individual application programs 84 to 92 is also transferred to the second interface program 82 which transfers this signaling information to the first interface program 80 of the coordination processor 66. The application programs 84 to 92 thus have unrestricted access to the signaling system of the telecommunication network 14. They utilize the SCCP/TCAP protocol stack 76, 78 of the coordination processor 66. This protocol stack 76, 78 of the coordination processor 66 is already present in known methods. The implementation of a further SCCP/TCAP protocol stack in the applications computer of the commercial platform 72 is not required. The first interface program 80 and the second interface program 82 need to be implemented. The relevant application program 84 to 92 serves as a TCAP user which, with the aid of the interface programs 80, 82, is in a physically separate location to the SCCP/TCAP protocol stack. The commercial platform 72 does not therefore need to have its own SCCP/TCAP protocol stack. Any platform can thus be chosen for the implementation of new TCAP users without there being a requirement for direct availability of SCCP/TCAP protocol stacks.

The interfaces 80, 82 can also be referred to as TCAP Application Interfaces (TIF), the first interface program 80 being designated as TIF User and the second interface program 82 as TIF TCAP. The first interface program TIF User 80 behaves toward the SCCP/TCAP protocol stack in the same way as a TCAP User, in other words in the same way as an ordinary user part. The second interface program TIF TCAP 82 behaves toward the relevant application program 84 to 92 in the same way as the SCCP/TCAP protocol stack. A physical separation is thus effected between application program 84 to 92 and signaling system of switching center 12e. By this means it is possible to ensure that signaling information is transferred over the link between the interface programs 80 and 82. Access by users of the Internet 18 to the program system of the switching center 12d is thus effectively prevented.

In a first implementation of the interface programs 80, 82, two platforms need to be adapted. The second interface program 82 is integrated into the commercial platform 72. The first interface program 80 is implemented in the program system of the coordination processor 66. Compared with the SCCP/TCAP protocol stack, however, these interface programs 80, 82 employ an extremely simple logic since they essentially “pass on” the signaling information in the form of user data. The protocol monitoring facility, the path selection function and also other functions thus have a simple structure and are completely transparent. Since these interfaces 80, 82 transfer data, they do not need to be modified when a change is made to services or to protocols, such as the protocol for the TCAP User for example.

With regard to the connection of further platforms, particularly platforms which are executed on other hardware systems and/or with the aid of other operating systems, the first interface program 80 can also be used without modification for these new platforms. The second interface program 82 may need to be adapted for the new platform or it may need to be newly written for this platform. If for dynamic reasons the second interface program 82 for a first platform is written using the “C” programming language for example, then this second interface program 82 must be newly written for a second platform. However, if the second interface program 82 has been written using a platform-independent programming language, such as the “Java” programming language for example, then the second interface program 82 can also be used without modification on other platforms unless it is necessary, for reasons of performance for example, to write the interface program in a platform-dependent programming language for this platform. As a result of the simple structure of the second interface program 82, there is not likely to be any major overhead involved in writing it, however.

It is possible that the first interface program 80 is connected to a plurality of interface programs such as the second interface program 82 of the commercial platform 72 and exchanges signaling information with these. However, it is also possible that a plurality of interface programs such as the first interface program 80 is connected to the SCCP/TCAP protocol stack 76, 78 of the coordination processor 66. Other interface programs, such as the first interface program 80, can also be connected to the SCCP/TCAP protocol stack of the group processor 62 or of the signaling processor 64. The installation work required to implement the interface programs 80, 82 is approximately 10% of the work required to implement a SCCP/TCAP protocol stack in the commercial platform 72.

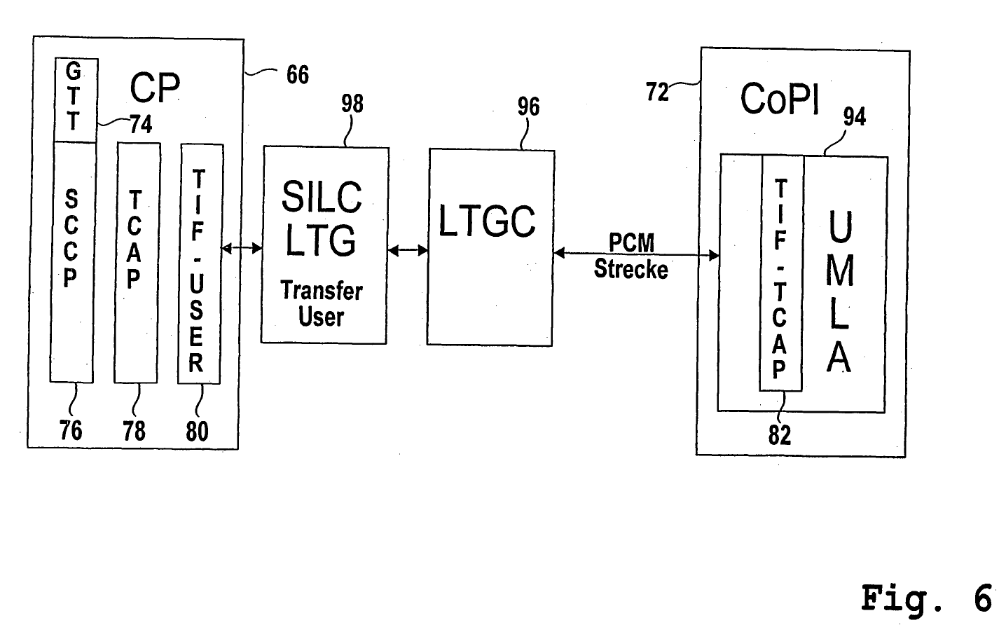

FIG. 6 shows a possible physical link between the first interface program 80 of the coordination processor 66 and the second interface program 82 of the commercial platform 72. The coordination processor 66 is a control computer in the EWSD switching center 12e (digital electronic switching system). In addition, the switching center 12e has a connection controller 98, a so-called Signaling Interface Link Controller (SILC) which terminates the signaling channels to the commercial platform 72. The connection controller 98 executes a “Transfer User” interface program which on the one hand terminates a data transfer protocol, for example the LAP-D protocol, on the transfer path between the commercial platform 72 and the connection controller 98 and on the other hand terminates the data transfer between the connection controller 98 and the coordination processor 66. The transferred data is copied transparently from a data container of a first protocol into a data container of a second protocol. No conversion of the data transferred or to be transferred is carried out here. The signaling data is transferred to a PCM connection unit, a PCM connection, in other words a PCM link, existing between this PCM connection unit 96 and the applications computer of the commercial platform 72.

The data is transferred on the PCM link with the aid of a pulse code modulation method. The TIF TCAP interface program 82 is part of a switching layer 94, the so-called Universal Mediation Layer. This switching layer is arranged in the commercial platform 72 in order to provide coordination and control of data transfer, particularly for data transfer using the PCM links.

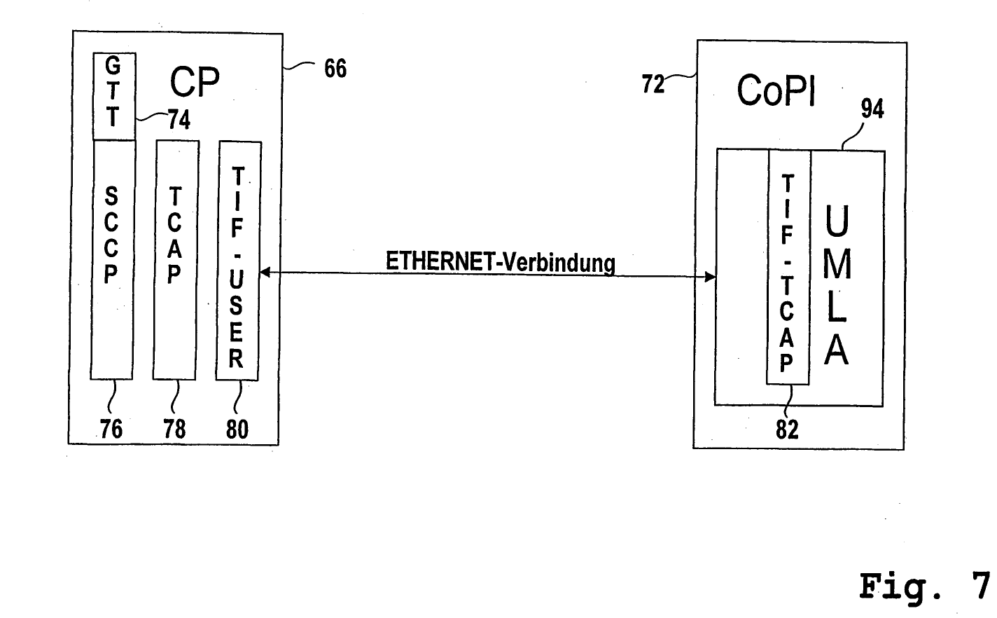

FIG. 7 shows a second exemplary embodiment of a possible physical link between the coordination processor 66 of the switching center 12e and the commercial platform 72. In this embodiment, the switching center 12e and the applications computer of the commercial platform 72 each have an interface which supports data transfer based on an Internet protocol. The data transfer of the signaling information between the commercial platform 72 and the signaling system 76, 78 of the coordination processor 66 takes place with the aid of an Ethernet link between these two interfaces.

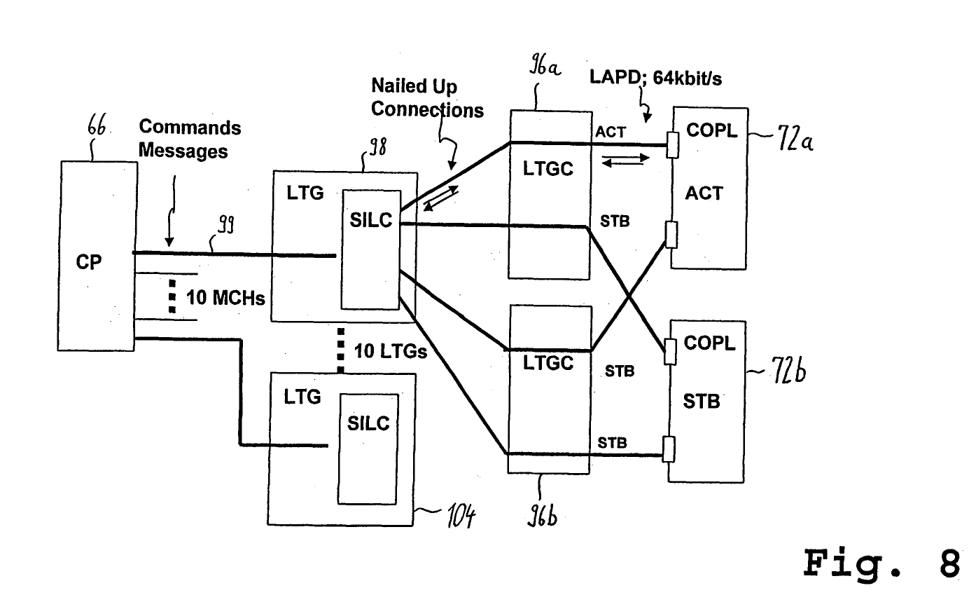

FIG. 8 shows a further exemplary embodiment of a possible physical link between the coordination processor 66, the switching center 12e and the commercial platform 72, wherein the commercial platform and the line trunk group C for controlling the PCM link between the applications computer of the commercial platform 72 and the switching center 12e are configured redundantly. The exemplary embodiment shown in FIG. 8 is similar to the exemplary embodiment shown in FIG. 6. However, the modules included in the redundant configuration for the exemplary embodiment in FIG. 8 have no redundant configuration in the exemplary embodiment shown in FIG. 6. The connection controller 98 is connected to the coordination processor 66 via a signaling channel. Further connection controllers are likewise each connected to a signaling channel of the coordination processor 66. Of these further connection controllers, one connection controller 104 is shown in FIG. 8. The connection unit C for connection of the PCM link between the commercial platform 72 and the connection controller 98 is redundantly configured as connection unit 96a and as connection unit 96b.

Two signaling channels are set up as fixed connections, as so-called nailed-up connections (NUC), in each case to connection unit 96a and to connection unit 96b. One data transmission channel with a transfer capacity of 64 kbit/s is set up in each case as a fixed connection between the connection unit 96a and the commercial platform 72a and also between the connection unit 96a and the commercial platform 72b, a LAP-D data transfer protocol being used for controlling the data transmission. One data transmission channel with a transfer capacity of 64 kbit/s is likewise set up in each case as a fixed connection between the connection unit 96b and the commercial platform 72a and also between the connection unit 96b and the commercial platform 72b, where the LAP-D data transfer protocol is likewise used.

The commercial platforms 72a and 72b can be arranged in a common applications computer. This applications computer should have at least two processors, at least one first processor handling the program data for provisioning the commercial platform 72a and at least one second processor handles the program data for provisioning the commercial platform 72b. In this arrangement the commercial platform 72a is active and the commercial platform 72b is on standby such that the commercial platform 72b can assume the functions of the commercial platform 72a without interruption in the event of failure of the commercial platform 72a.

One signaling channel between the connection controller 98 and the line trunk groups 96a, 96b is activated. The other three links shown are in a standby state and can be activated as and when required. Thus, for example, the link between the connection controller 98 and the commercial platform 72a is activated in the event of failure of the line trunk group 96a, which is routed via the line trunk group 96b. In the event of failure of the commercial platform 72a, the aforementioned commercial platform 72b is activated, the signaling channel between the connection controller 98 and the commercial platform 72b being activated, the channel being routed via the line trunk group 96a. If the commercial platform 72b has been activated and if the line trunk group 96a fails, then the link between connection controller and commercial platform 72b is activated, the link being routed via the line trunk group 96b.

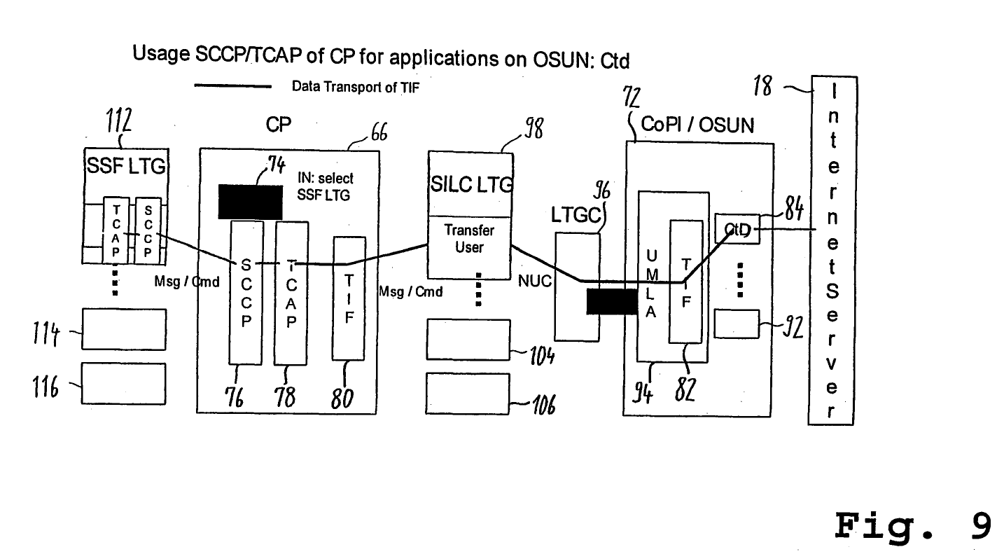

FIG. 9 shows the link between the coordination processor 66 of the switching center 12e and the commercial platform 72 of the first embodiment from FIG. 6 with additional elements. The commercial platform 72 is also referred to as an Open Service Unit (OSUN) or as an open system platform, the commercial platform 72 likewise having a link to the Internet 18. This link to the Internet 18 is effected via a further interface which is not shown. The application programs on the commercial platform 72 can be modified by an operator of the platform 72 to suit his needs. The operator of the platform 72 need not be the operator of the switching center 12e. As a result of the physical separation of commercial platform 72 and switching center 12e, there is a clear distinction of responsibilities when there are different operators for the switching center 12e and the commercial platform 72. The operator of the commercial platform 72 can assume responsibility for modifications particularly to the application programs. The commercial platform 72 can also be arranged to be physically separated from the switching center 12e.

Any manipulation of the switching center 12e by means of the commercial platform 72 is excluded since the commercial platform 72 has no direct access to the signaling system and the program system of the switching center 12e. The first interface program 80 simply passes on signaling information to the signaling system of the coordination processor 66. Manipulation activities, particularly concerning the program system of the switching center 12e, are thus excluded. The interface programs 80, 82 thus also serve as filters between the commercial platform 72 and the switching center 12e. Such a filter is also referred to as a firewall. In contrast to FIG. 6, FIG. 9 shows further connection controllers 104, 106 which are similar in structure to the connection controller 98. In addition, a signaling system 112 of the switching center 12a is shown. This signaling system serves to provide service signaling functions and has an SCCP/TCAP protocol stack 108, 110. The signaling systems of further switching centers in the telecommunication network 14 are shown by way of example as signaling systems 114, 116.

An application program 84, which is also referred to as the Click to Dial application program, serves to make it possible for a user of the Internet 18 to establish a voice connection with a subscriber of the telecommunication network 14 via the user interface offered by an Internet page. The applications computer, which serves as the commercial platform 72, has a link to an Internet server on the Internet 18. For example, a so-called Internet page serves to offer the user the facility of a voice connection to an expert in a particular specialist field. This could, for example, be an expert for an application program which the user of the Internet 18 uses on his applications computer. The user can thus activate the Internet page of the manufacturer in this application software with the result that he sees displayed the contents of this Internet page on his applications computer. He can work through the help offered on this page, which is usually presented in text form, in order to find a solution for his problems.

In addition, an input field allows him to request advice and/or assistance by telephone from an expert. To this end the subscriber data, in particular the number of the telephone connection of the subscriber, is transferred via the Internet 18 to the application program 84 on the commercial platform 72. The subscriber data for the user is converted by the application program 84 into signaling information which the application program 84 passes on to the second interface program 82. As described above, the signaling information is transferred in the form of data to the first interface 80 which is arranged in the switching center 12e and is connected to the signaling system 74, 76, 78 of the coordination processor 66. The signaling information of the application program 84 is thus passed on to the signaling system of the telecommunication network 14.

With the aid of the signaling network of the telecommunication network 14, the signaling information is transferred to the signaling system 112 of the switching center 12a to which the subscriber line of the expert is connected, and to which a telephone connection is to be established. With the aid of the signaling information transferred to the signaling system 112, a connection is established between the subscriber line of the user and the subscriber line of the expert.

In other exemplary embodiments, connection establishment and connection control between the expert and the user are handled with the aid of a further switching center or with the aid of a further network element of the telecommunication network 14. From the viewpoint of the commercial platform 72, the subscriber lines of the user and of the expert are situated at any desired point in the telecommunication network 14. The network section of the telecommunication network 14 in which the switching center of the user and/or the expert is situated can also be operated by a network operator other than that which operates the switching center to which the commercial platform 72 is connected. The signaling system 112 shown in FIG. 9 can thus be implemented by means of any desired network element of the telecommunication network 14. The signaling system 112 evaluates the signaling information from the application program 84 and uses the numbers provided by the application program 84 to establish a connection between the subscriber and the expert, switch a connection and carry out call charging for this connection. The application program 84 thus uses the standard functions of the telecommunication network 14.

If the user has an analog subscriber line with one subscriber line and if he uses this subscriber line for his Internet access, then this data connection to the Internet 18 is interrupted automatically by the switching center 12e to which the subscriber line of the user is connected. The voice connection between the subscriber line of the expert and the subscriber line of the user is subsequently switched through. If the user has an ISDN connection with two user information channels or if the user has an access to the Internet 18 which does not use his telephone connection, then the Internet connection is not interrupted because at least one free channel is available via which the voice connection between the expert and the user can be switched. In other embodiments it is however also possible to switch a voice connection between user and expert via the Internet 18.

The transfer of signaling data between the Internet 18 and the telecommunication network 14 is also necessary with regard to other services and features, such as the Click to Conference function or the Call Waiting on Internet Busy function for example. With the Call Waiting on Internet Busy service, a called subscriber sees a display indicating that another subscriber on the telecommunication network wishes to conduct a call with him while his connection is blocked by a connection to the Internet 18. In this situation, for example, the number of the calling subscriber can also be displayed to the called subscriber. With the Call Waiting on Internet Busy service, the signaling information for the telecommunication network 14 is transferred to a corresponding application program on the commercial platform 72 which carries out the conversion into an IP signaling message. This service is thus initiated by the telecommunication network 14.

With the Click to Conference service, a subscriber can set up a conference facility between a plurality of subscribers on the telecommunication network via a corresponding Internet page. The subscriber who convenes the conference enters the telephone numbers of the desired subscribers on an Internet page of a provider who offers a function of this type. This data is transferred to the corresponding application program, to the application program 92 on the commercial platform 72 for example. The application program 92 passes corresponding signaling data to the interface program 82 which passes on this signaling information to the interface 80 of the switching center 12e. With the aid of the signaling system 74, 76, 78 of the coordination processor 66, the transferred signaling information is passed to the signaling network of the telecommunication network 14 and transferred to a conference control unit for the telecommunication network 14. This conference control unit establishes a connection to all potential participants involved in the conference and interconnects these subscribers. The conference control unit can be arranged in the same switching center to which the commercial platform 72 is connected and on which the Click to Conference application program 92 is executed. The commercial platform 72 is, for example, a so-called open system platform.

With the aid of further signaling data which can be generated automatically, the application program 92 on the commercial platform 72 controls the convening of the conference; in particular, this is signaling data which is used to switch a connection for a welcome announcement and then for a waiting announcement to the subscriber line of each potential participant in the teleconference. The communication partner of the Click to Conference application program 92 is the conference control unit. The conference control unit is a so-called Intelligent Network Application Part (INAP). As far as the switching centers for the subscriber lines of the conference participants are concerned, the connection establishment is a conventional connection establishment from a calling subscriber to the subscriber on the subscriber connection of the switching center in question. The conference control unit thus establishes a separate connection to each of the subscribers, joins the user information channels together and handles the connection control for the connections to the individual conference participants. The application program 92 on the commercial platform 72 can be supplied with data which can be displayed on the Internet page to the subscriber who has convened the teleconference and thereby inform him about the convening status of the teleconference.

The connection between the interfaces 80, 82 can also be implemented with the aid of any other desired physical connection used for data transmission. Any other data transfer protocol can also be used for data transfer between the interfaces. As far as the switching centers and control units of the telecommunication network 14 are concerned, the exchange of signaling information with the application programs 84, 92 on the commercial platform 72 via the interfaces 80, 82 is just as transparent as in the case of direct access by the commercial platform 72 to the signaling system of the telecommunication network 14.

1. Arrangement for operating a telecommunication network (14) which comprises at least one network element (12e for example), having:
(1) at least one control computer (66) by which the network element (12e) is controlled, wherein the control computer (66) comprises:
its operating system,
at least one first interface program (80),
a signaling program (76, 78) which implements signaling operations between the control computer (66) and further control computers (34, 36, 38) of the telecommunication network (14),
(2) at least one applications computer (72) which is connected directly to the control computer (66), wherein the applications computer comprises:
an operating system assigned to it,
at least one second interface program (82),
at least one application program (84 to 92), by means of which at least one service is made available, signaling information needing to be exchanged with the telecommunication network (14) in order to implement said service, where in order to exchange the signaling information
with the aid of the second interface program (82), data containing the signaling information is transferred to and received by the first interface program (80),
the signaling information from the data transferred by the second interface program (82) is delivered with the aid of the first interface program (80) to the signaling program of the network element (12e), and
wherein signaling information for the application program (84 to 92) is supplied with the aid of the signaling program (76, 78) of the network element (12e) to the first interface program (80) which transfers data containing this signaling information to the second interface program (82), the received signaling information being supplied to the application program (84 to 92) with the aid of the second interface program (82).

2. Arrangement according to claim 1, characterized in that the signaling information comprises only a subset of all the signaling information made available by the signaling program (76, 78).

3. Arrangement according to claim 1, characterized in that the applications computer (72) is connected to the control computer (66) on a point-to-point basis.

4. Arrangement according to claim 1, characterized in that the signaling program (76, 78) of the control computer (66) and signaling programs of the further control computers (34, 36, 38) constitute a self-contained signaling network within the telecommunication network (14), whereby fixed signaling channels are set up between the control computers (66, 34, 36, 38).

5. Arrangement according to one of the preceding claims, characterized in that the signaling operations are carried out with the aid of the Signaling System No. 7.

6. Arrangement according to one of the preceding claims, characterized in that the signaling program (76, 78) provides services to at least one user part.

7. Arrangement according to claim 4, characterized in that the first interface program (80) is a user part of the signaling program (76, 78).

8. Arrangement according to one of the preceding claims, characterized in that the signaling functions which the signaling program (76, 78) has at its disposal are made available to the application program (84 to 92) with the aid of the second interface program (82).

9. Arrangement according to one of the preceding claims, characterized in that the data transfer between the first and the second interface program (80, 82) takes place with the aid of an LAP-D data transfer protocol or with the aid of a data transfer protocol which is based on an Internet transfer protocol.

10. Arrangement according to one of the preceding claims, characterized in that the application program (84 to 92) is connected to a network (18) based on an Internet protocol, and that services which require an exchange of signaling information with the telecommunication network (14) are made available to a subscriber over this network (18) with the aid of the application program (84 to 92).

11. Method for operating a telecommunication network (14) which comprises at least one network element (12e for example), having
at least one control computer (66) by which the network element (12e) is controlled, wherein in addition to its operating system the control computer (66) has at least one first interface program (80) and also a signaling program (76, 78) which implements signaling operations between the control computer (66) and further control computers (34, 36, 38) of the telecommunication network, and
at least one applications computer (72) which is connected directly to the control computer (66) and which in addition to the operating system assigned to it has at least one second interface program (82) and also at least one application program (84 to 92), by means of which at least one service is made available, signaling information needing to be exchanged with the telecommunication network (14) in order to implement said service,
wherein in order to exchange the signaling information with the aid of the second interface program (82) data containing signaling information is transferred to and received from the first interface program (80), the signaling information from the data transferred by the second interface program (82) is delivered with the aid of the first interface program (80) to the signaling program of the network element (12e), and wherein signaling information for the application program (84 to 92) is delivered with the aid of the signaling program (76, 78) of the network element (12e) to the first interface program (80) which transfers data containing this signaling information to the second interface program (82), the received signaling information being delivered to the application program (84 to 92) with the aid of the second interface program (82).
